(19) United States
(12) Patent Application Publication
(10) Pub. No.: US 2025/0371897 A1
(43) Pub. Date: Dec. 4, 2025

(54) METHODS, SYSTEMS, ARTICLES OF MANUFACTURE, AND APPARATUS TO DETERMINE CONFIDENCE METRICS ASSOCIATED WITH TEXT RECOGNITION MODELS AND CLASSIFICATION MODELS

(71) Applicant: Nielsen Consumer LLC, Chicago, IL (US)

(72) Inventors: Roberto Arroyo, Guadalajara (ES); Elena Martinez, Chicago, IL (US); Silvia Duque, Valladolid (ES); Javier Lorenzo Diaz, Chicago, IL (US); Hector Corrales, Madrid (ES)

(21) Appl. No.: 18/680,323

(22) Filed: May 31, 2024

(51) Int. Cl. G06V 30/19; G06F 16/55; G06F 16/583; G06F 40/279; G06V 30/24

(52) U.S. Cl. CPC G06V 30/19173; G06F 16/55; G06F 16/5846; G06F 40/279; G06V 30/19007; G06V 30/2528

(57) ABSTRACT

Methods, systems, articles of manufacture, and apparatus to determine confidence metrics associated with text recognition models and classification models are disclosed. An example apparatus comprises interface circuitry, machine-readable instructions, and at least one processor circuit to be programmed by the machine-readable instructions to cause a text recognition model to predict characters in an image, and determine first confidence metrics associated with sets of the predicted characters, cause a classification model to classify the sets of the predicted characters by determining predicted classifications for the sets of the predicted characters, and determine second confidence metrics associated with the predicted classifications, determine third confidence metrics based on the first confidence metrics and the second confidence metrics, compare the third confidence metrics to a threshold, and in response to the third confidence metrics satisfying the threshold, prevent a transmission of the image to a database.

### FIELD OF THE DISCLOSURE

This disclosure relates generally to computer-based image analysis and, more particularly, to methods, systems, articles of manufacture, and apparatus to determine confidence metrics associated with text recognition models and classification models.

### BACKGROUND

Artificial intelligence (AI) leverages computers and machines to mimic problem solving and decision making challenges that typically require human intelligence. Machine learning (ML), deep learning (DL), computer vision (CV), and natural language processing (NLP) are powerful AI techniques that can work together to process an image. For example, these AI techniques can be applied to an image of a purchase document to extract information.

### BRIEF DESCRIPTION OF THE DRAWINGS

FIG. 1 is a block diagram of an example environment in which example filter circuitry operates to determine confidence metrics.

FIG. 2A is an example receipt that can be included in example input files of FIG. 1.

FIG. 2B illustrates how the example filter circuitry determines confidence metrics associated with the example receipt of FIG. 2A.

FIG. 3 is another example receipt that can be included in the example input files of FIG. 1.

FIG. 4 is yet another example receipt that can be included in the example input files of FIG. 1.

FIG. 5A illustrates example first and second distributions.

FIG. 5B is an example box and whisker plot of the first and second distributions of FIG. 5A.

FIG. 6A illustrates example third and fourth distributions.

FIG. 6B is an example box and whisker plot of the third and fourth distributions of FIG. 6A.

FIGS. 7 and 8 are a flowcharts representative of example machine readable instructions and/or example operations that may be executed, instantiated, and/or performed by example programmable circuitry to implement the filter circuitry of FIG. 1.

FIG. 9 is a block diagram of an example processing platform including programmable circuitry structured to execute, instantiate, and/or perform the example machine readable instructions and/or perform the example operations of FIGS. 7 and 8 to implement the filter circuitry of FIG.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 7 and 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Image recognition involves computer-aided techniques to analyze pictures, photographs, images, etc., to determine and/or identify the content of the captured scene. Industries, such as retail establishments and/or product manufacturers, may rely on image recognition techniques to inform significant business decisions. For example, in a retail establishment, image recognition techniques can evaluate invoices, timecards, receipts, and/or any other store data to determine whether to increase inventory at the retail establishment, perform financial audits on invoices, read product barcodes, assess textual information about a product, etc.

Machine learning (ML), deep learning (DL), computer vision (CV), and natural language processing (NLP) are powerful artificial intelligence (AI) techniques that can work together to process an image. For example, text recognition models (e.g., an optical character recognition (OCR) model) can access and/or scan a document to provide text recognition. Further, classification models (e.g., a NLP model) can access and/or scan a document to sort text regions of interest into one or more categories/classifications (e.g., price, product name, amount, etc.). Typically, after one or more text recognition models have analyzed an example image, a confidence metric is assigned to one or more outputs. For example, a text recognition model can assess an image, provide textual identifications associated with the image (e.g., characters, strings of characters, etc.), and determine a confidence metric (e.g., a numeric value) for each of the textual identifications that indicate (e.g., numerically) how likely the textual identifications are correct (e.g., true, accurate, etc.). In some examples, a confidence metric is a percentage value. In some examples, a confidence metric is a decimal value between zero (0.00) and one (1.00), in which relatively higher values are indicative of a relatively greater confidence that a particular prediction or estimation is accurate. Similarly, a classification model can assess an image, provide classifications associated with the text (e.g., the textual identifications from the text recognition models), and determine a confidence metric for each of the classifications that indicate how likely the classifications are correct. In some examples, an auditor manually reviews confidence results to verify the accuracy and/or make corrections. Further, the auditor may adjust or modify information in the results. Such a human-based process is time-consuming and error-prone due to human discretion, inconsistencies across different human auditors and/or inconsistencies of a same human auditor over time.

However, complex image formats, low resolution images, and/or multilingual content are among some of the difficulties that example image recognition techniques face while identifying image content. For example, identification errors occur when an image has poor resolution or quality. As such, confidence metrics outputted from a text recognition model or a classification model are suspect, unreliable, and/or untrustworthy. Further, an auditor that manually reviews these documents with confidence metrics may be unable to detect any identification and/or classification errors.

Examples disclosed herein provide a global perspective of confidence metrics for an example image assessed by Al image recognition techniques. For instance, disclosed examples consider confidence metric outputs from a text recognition model and confidence metric outputs from a classification model to determine a final, combined, global, etc., confidence metric for each character (e.g., letter, number, mark, etc.) in the corresponding image. Disclosed examples determine a threshold confidence level that is, in turn, utilized to determine which of the characters in an example image have corresponding global confidence metrics that indicate additional review/processing is needed. If a given image includes characters having low confidence metrics, instead of transmitting the entire document(s) via one or more networks to facilitate manual reassessment of the entire document to correct any identification or classification errors, examples disclosed herein reduce bandwidth burdens by only flagging certain characters or groups of characters (e.g., words) for subsequent reassessment. As such, disclosed examples significantly reduce a volume of information to be transmitted over data networks and reduce the amount of human intervention required to review results of image recognition techniques. Examples disclosed herein significantly reduce or eliminate a need for auditors to spend numerous hours reviewing the result of the image recognition process, thus conserving processing resources, facilitating faster process executing, and/or helping green energy conservation initiatives.

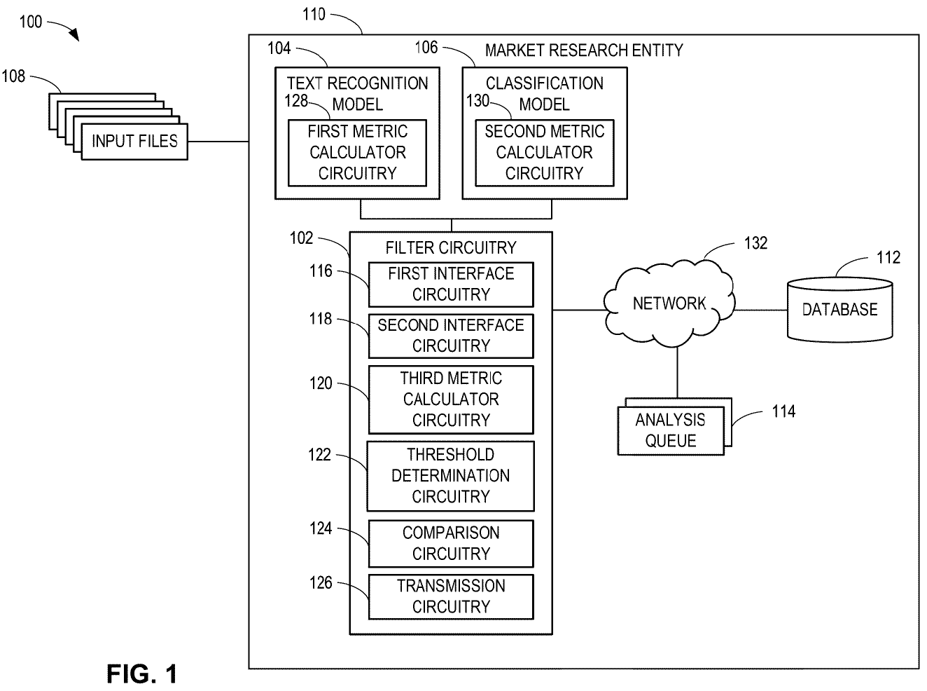

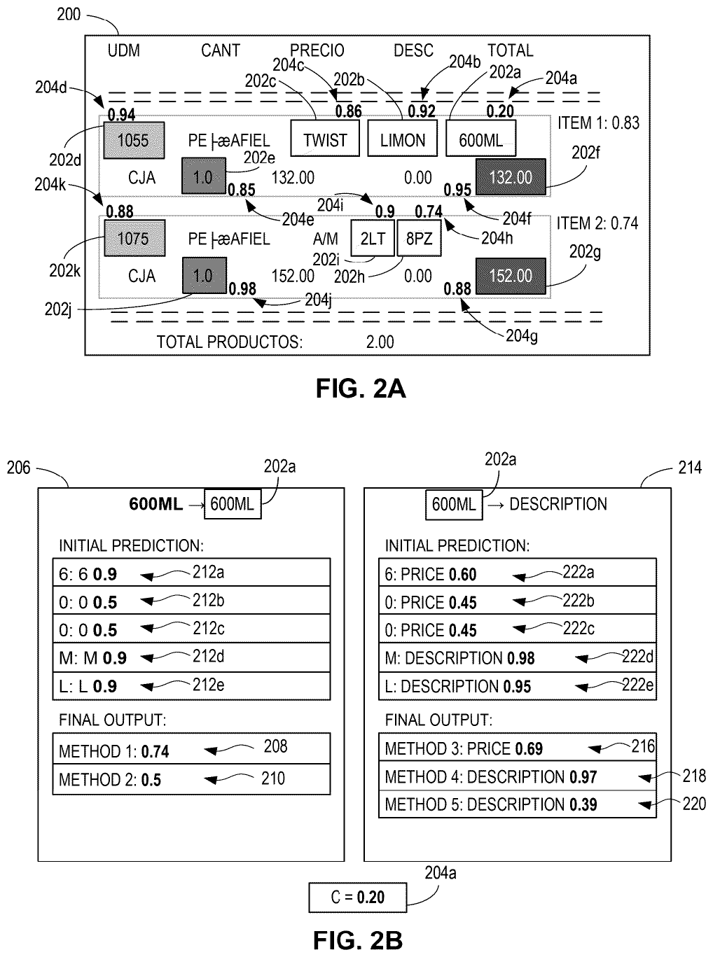

FIG. 1 is a block diagram of an example environment 100 in which example filter circuitry 102 operates to determine confidence metrics associated with output data from an example text recognition model 104 and an example classification model 106. In the example of FIG. 1, the example text recognition model 104 and the example classification model 106 access input files 108 including, for example, receipts. While examples disclosed herein are applied to receipts, examples disclosed herein can be applied to other documents as well, such as invoices and/or other purchase documents. Further, examples disclosed herein can be applied to extraction and decoding of images in other industries or applications, such as historical document digitization, banking and commercial operations, mail sorting, hospital records, medical notes, pharmaceuticals, etc. In some examples disclosed herein, characters from medication labeling systems may be assessed to determine performance accuracy, thereby reducing instances of patient confusion and/or life-threatening medication dosing errors. In some examples, the filter circuitry causes generation of a report based on accuracy results. For example, disclosed examples generate an example warning report including the original image (e.g., invoice image) with overlaying regions of highlight/color, as well as textual indications of accuracy adjacent to the corresponding regions (FIGS. 2A, 3, and 4), that emphasize areas in need of additional review and/or processing. As such, disclosed examples transform the original image into a computer-generated document including graphics, text, and/or accuracy results.

While examples disclosed herein may apply to any industry, a market research industry and its corresponding environment are described for the sake of convenience, but not limitation. For instance, the example environment 100 includes an example market research entity 110 that can gather the input files 108 from a variety of resources, such as market cooperators (e.g., retailers, auditors, cooperating consumers, etc.) and/or any other entity that collects receipts from consumers and/or retailers. In some examples, the market research entity 110 obtains a digital version of a receipt. However, the market research entity 110 often acquires an image of the receipt captured via an electronic device such as a cellphone, a mobile computer having a camera, etc. For example, a market coordinator captures an image of a receipt or an invoice and transmit the image to the market research entity 110 to, in turn, transmit the image to the text recognition model 104 and/or the classification model 106 for processing (e.g., extraction, decoding, etc.). In some examples, the market research entity 110 is implemented by one or more servers, such as a network accessible physical processing center. Further, the market research entity 110 can be any other type of entity such as a pharmaceutical entity, a healthcare entity, a government entity, an educational entity, a manufacturing entity, etc.

The example filter circuitry 102 assesses example confidence metrics from the text recognition model 104 and the classification model 106 to sort the input files 108 into one of two categories. For example, the filter circuitry 102 determines which of the input files 108 need to be reassessed via further processing (e.g., Category A) and which of the input files 108 include passing confidence metrics such that processing is complete (e.g., Category B). The example input files 108 associated with Category B are relied upon by auditors and/or other market cooperators to assess store inventory, make business decisions, etc. In some examples, the ones of the input files 108 associated with Category B are stored in an example database 112.

On the other hand, the example input files 108 associated with Category A have not satisfied a confidence threshold, thus indicating additional processing power may be needed to achieve a reliable result. In some examples, the ones of the input files 108 associated with Category A are flagged for further analysis in an example analysis queue 114. The example filter circuitry 102 disclosed herein significantly reduces the amount of the input files 108 that would otherwise be categorized as Category A. In other words, the example filter circuitry 102 disclosed herein reduces or eliminates the power consumption, data storage, and processing capabilities that were otherwise needed to correct any identification and/or classification errors resulting from analysis at the text recognition model 104 and/or the classification model 106. In some examples, but for the filter circuitry 102, the number of the input files 108 sorted to Category A would greatly exceed (e.g., by 100 files, by 1000 files, etc.) the number of the input files sorted to Category B. As such, the financial cost of expensive processing equipment, computing power, thermal management, and/or the storage capability associated with any server, processor, model, etc., programmed to re-analyze the input files 108 sorted to Category A in the analysis queue 114 is beneficially alleviated with the incorporation of the filter circuitry 102 as disclosed herein.

The example filter circuitry 102 includes example first interface circuitry 116, example second interface circuitry 118, example third metric calculator circuitry 120, example threshold determination circuitry 122, example comparison circuitry 124, and example transmission circuitry 126. The filter circuitry 102 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the filter circuitry 102 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example first interface circuitry 116 causes the text recognition model 104 to predict characters in an image. For example, the first interface circuitry 116 causes the text recognition model 104 to predict characters in an image of a first receipt included in the input files 108. In turn, the example text recognition model 104 accesses the image of the first receipt from the input files 108, scans the image, and predicts the characters in the image. As used herein, the phrase “predicted characters” refers to the textual output of the text recognition model 104 in calculating/determining the characters in the image. In other words, a “predicted character” is an output from the text recognition model 104 indicative of a character having a relatively highest numerical likelihood value when compared to two or more other candidate characters in the image.

The example first interface circuitry 116 causes the text recognition model 104 to determine first confidence metrics associated with sets of the predicted characters. The example text recognition model 104 includes example first metric calculator circuitry 128 to determine the first confidence metrics. For example, the first metric calculator circuitry 128 determines the first confidence metrics associated with sets of the predicted characters. As used herein, the phrase “sets of the predicted characters” refers to predicted words and/or other combinations of predicted characters. For example, a set of predicted characters corresponds to any combination of two or more predicted letters (e.g., “limon”), at least two of a predicted number and one or more predicted letters (e.g., “600 mL”), one or more predicted numbers and a predicted symbol (e.g., “$4,” “1.0,” etc.), at least one number (e.g., “1”), at least one predicted character (e.g., “a”), etc. The example first metric calculator circuitry 128 determines the first confidence metrics as likelihood values to determine how certain the sets of the predicted characters are true (e.g., accurate with respect to the actual sets of the characters in the image). In some examples, the first metric calculator circuitry 128 determines the first confidence metrics associated with sets of the predicted characters based on confidence values associated with each of the predicted characters, as described in connection with FIG. 2B.

The example second interface circuitry 118 causes the classification model 106 to classify the sets of the predicted characters by determining predicted classifications for the sets of the predicted characters. As used herein, the phrase “predicted classification” refers to a class/category output of the classification model 106 in guessing/predicting the classification of a set of the predicted characters. In some examples, a predicted classification is a price, description, amount, product name, product type, barcode number, etc., as described in connection with FIG. 2B.

The example second interface circuitry 118 causes the classification model 106 to determine second confidence metrics associated with the predicted classifications. The example classification model 106 includes example second metric calculator circuitry 130 to determine the second confidence metrics. For example, the second metric calculator circuitry 130 determines the second confidence metrics associated with the predicted classifications as likelihood values to determine how certain the predicted classifications are true (e.g., accurate with respect to the actual classifications of the sets of the characters in the image). In some examples, the second metric calculator circuitry 130 determines the second confidence metrics for the predicted classifications based on predicted classifications associated with each of the predicted characters, as described in connection with FIG. 2B.

To rely on only the first confidence metrics (e.g., metrics only associated with text/characters) or only the second confidence metrics (e.g., metrics only associated with classifications) could corrupt a determination of an image as Category A (e.g., needing additional review) or Category B (having completed review). For example, to rely on only the first confidence metrics may cause an image to be sorted into Category B even though the image has at least one incorrect predicted classification. Similarly, to rely on only the second confidence metrics may cause an image to be sorted into Category B even though the image has at least one incorrect set of predicted characters. The example third metric calculator circuitry 120 determines third confidence metrics (e.g., combined text/classification metrics) based on the first confidence metrics (from the text recognition model 104) and the second confidence metrics (from the classification model 106). For example, the third metric calculator circuitry 120 determines the third confidence metrics (e.g., sometimes referred to herein as “combined confidence metrics”) by multiplying the first confidence metrics and the second confidence metrics. In other words, for each set of predicted characters, the example third metric calculator circuitry 120 multiplies a first confidence metric (determined by the text recognition model 104) and a second confidence metric (determined by the classification model 106) to determine a third confidence metric (e.g., a combined confidence metric, a synthesized confidence metric, etc.). As such, each set of predicted characters includes a corresponding combined (e.g., third) confidence metric.

The example threshold determination circuitry 122 determines whether to generate, determine and/or otherwise revise a threshold or access an existing threshold. In some examples, the threshold determination circuitry 122 determines a threshold periodically, aperiodically and/or based on one or more triggers. In other examples, the threshold determination circuitry 122 determines a threshold when the image is a first (e.g., first in time) image included in the input files 108 being used to train at least one of the text recognition model 104 or the classification model 106. Alternatively, if the image is a first image in a series of images subject to processing by the filter circuitry 102, then the threshold determination circuitry 122 accesses the threshold (e.g., the threshold determined by the threshold determination circuitry 122 during one or more previous training phase(s)). In other words, each time the filter circuitry 102 is faced with a new batch of receipt images to scan and process, the threshold determination circuitry 122 can access a previously determined threshold to sort and process the new batch (e.g., beginning with a first receipt image in the new batch).

In some examples, the threshold determination circuitry 122 determines the threshold by determining distributions based on different groups of the combined confidence metrics. For example, a first group of the combined confidence metrics may be associated with first sets of the predicted characters having true predicted characters and true predicted classifications. In other words, the first group of the combined confidence metrics include sets of the predicted characters that were both correctly identified (e.g., true/correct predicted characters) and correctly classified (e.g., true/correct predicted classifications). Alternatively, a second group of the combined confidence metrics may be associated with second sets of the predicted characters having at least one of false predicted characters or false predicted classifications. In other words, the second group of the combined confidence metrics include sets of the predicted characters that were at least one of incorrectly identified (e.g., false/incorrect predicted characters) or incorrectly classified (e.g., false/incorrect predicted classifications). In some examples, the threshold determination circuitry 122 accesses inputs (e.g., from an example auditor) that indicate whether the predicted characters are true (e.g., correct) or false (e.g., incorrect). Additionally, the example threshold determination circuitry 122 accesses inputs (e.g., from the example auditor) that indicate whether the predicted classifications are true or false. In some examples, such an auditor is an employee trained by the market research entity 110, has personal knowledge of the industry, and/or can do research to determine whether the predicted characters are true or false and/or whether the predicted characters are true or false.

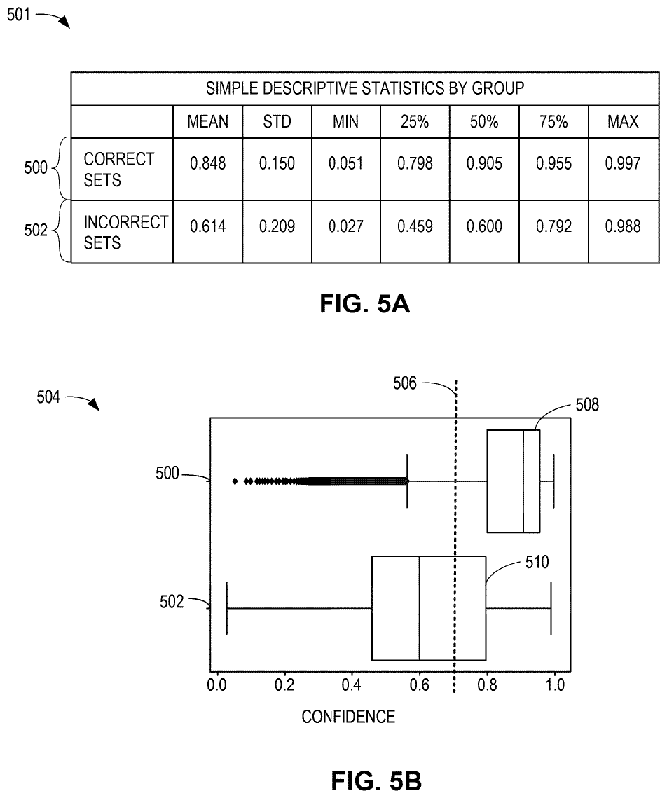

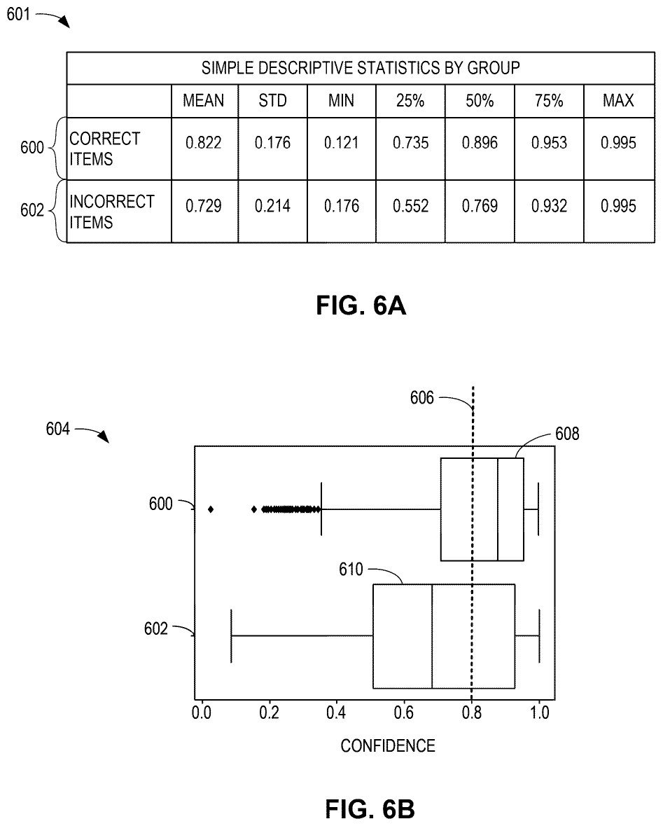

The example threshold determination circuitry 122 determines a first distribution based on the first group of the combined confidence metrics and a second distribution based on the second group of the combined confidence metrics. In turn, the example threshold determination circuitry 122 determines the threshold based on the first distribution and the second distribution, as described in detail in connection with at least FIGS. 5 and 6.

The example comparison circuitry 124 compares the combined confidence metrics to the threshold. In particular, the comparison circuitry 124 determines whether at least one of the combined confidence metrics does not satisfy the threshold. For example, if a first one of the combined confidence metrics (associated with a first set of the predicted characters) is 0.5 and the threshold is 0.7, then the example comparison circuitry 124 determines that the first one of the combined confidence metrics does not satisfy the threshold (e.g., 0.5<0.7). In such examples, it is likely that at least one of (i) a first confidence metric (associated with the first set of the predicted characters) indicates that the first set of predicted characters is false/incorrect or (ii) a second confidence metric (associated with the first set of the predicted characters) indicates that the predicted classification is false/incorrect. In other words, the first set of predicted characters is likely at least one of falsely predicted or falsely classified, therefore causing the first one of the combined confidence metric to not satisfy the threshold.

Alternatively, the example comparison circuitry 124 determines that a second one of the combined confidence metrics satisfies the threshold. For example, if the second one of the combined confidence metrics (associated with a second set of the predicted characters) is 0.9 and the threshold is 0.7, then the example comparison circuitry 124 determines that the second one of the combined confidence metrics satisfies the threshold (e.g., 0.9>0.7). In such examples, it is likely that a first confidence metric (associated with the second set of the predicted characters) indicates that the second set of the predicted characters is true/correct and a second confidence metric (associated with the second set of the predicted characters) indicates that the predicted classification is true/correct. In other words, the second set of the predicted characters is likely both correctly predicted and correctly classified, therefore causing the second one of the combined confidence metrics to satisfy the threshold.

In some examples, if the comparison circuitry 124 determines that each of the combined confidence metrics satisfies (e.g., is greater than) the threshold, then the example transmission circuitry 126 enables transmission of the image to the example database 112. In other words, when the comparison circuitry 124 determines that the combined confidence metrics satisfy the threshold, then the example comparison circuitry 124 determines that the image is associated with Category B (e.g., having completed processing), and the transmission circuitry 126 enables transmission of the image to the database 112. For example, the transmission circuitry 126 transmits the image to the database 112 via an example network 132.

Alternatively, if the comparison circuitry 124 determines that at least one of the combined confidence metrics does not satisfy the threshold, then the example transmission circuitry 126 prevents transmission of the image to the example database 112. In other words, when the comparison circuitry 124 determines that at least one of the combined confidence metrics exceeds (e.g., is less than) the threshold, then the comparison circuitry 124 determines that the image is associated with Category A (e.g., in need of additional processing), and the transmission circuitry 126 prevents transmission of the image to the database 112. Further, the example transmission circuitry 126 transmits the image to the analysis queue 114 (e.g., via the network 132) for further processing.

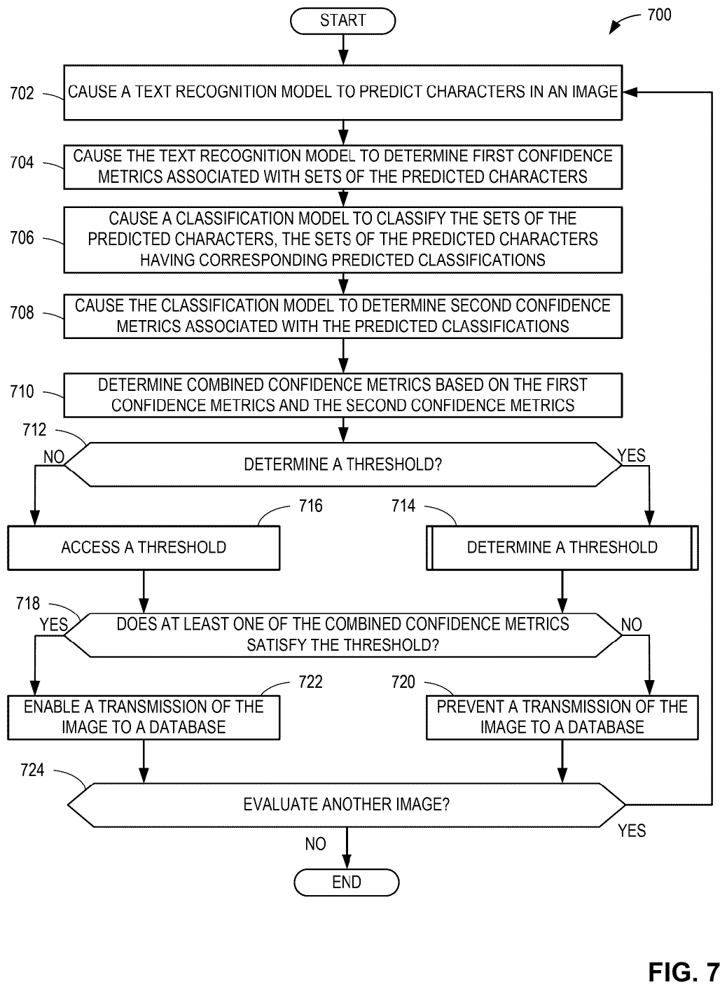

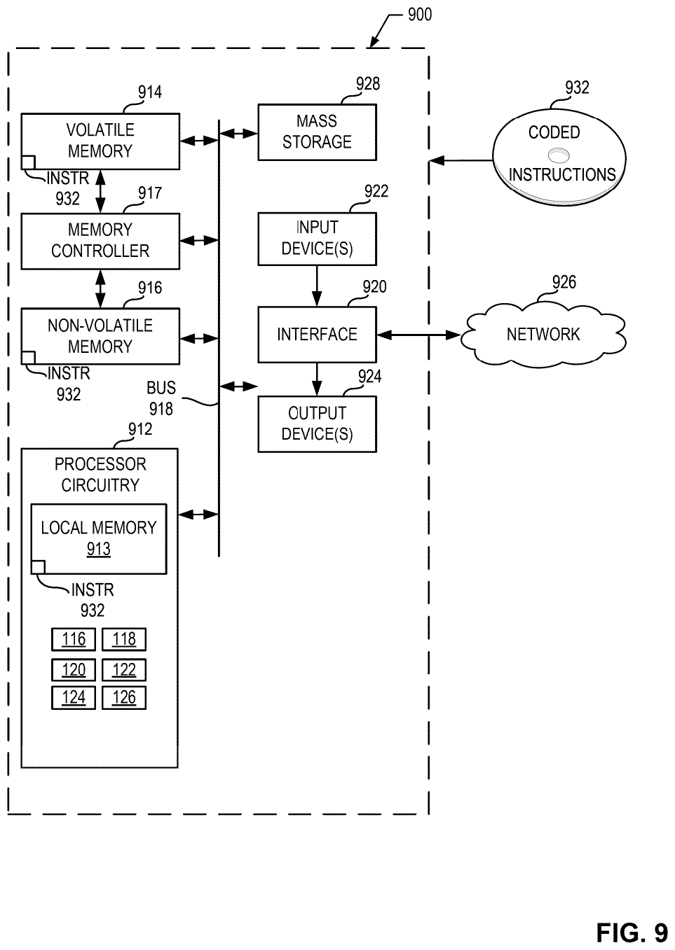

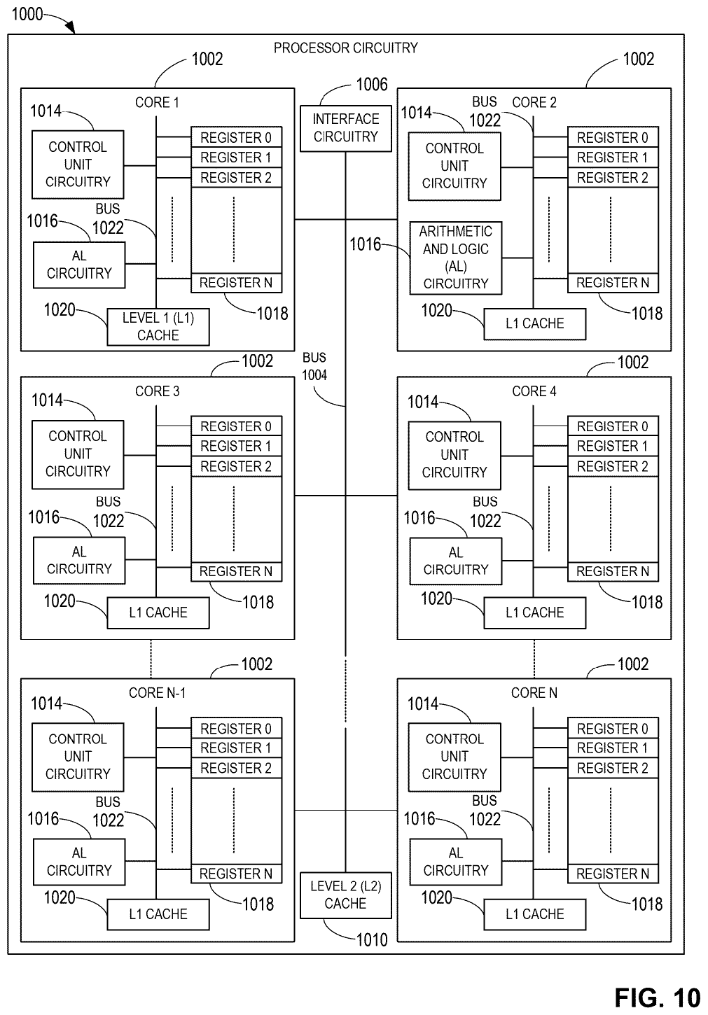

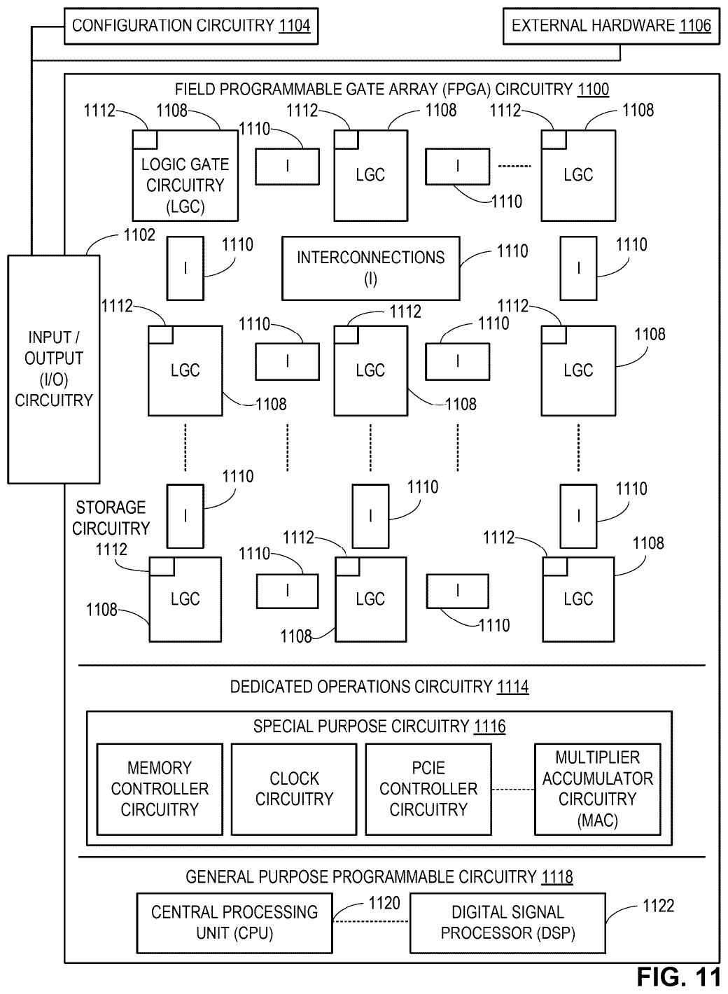

In some examples, the first interface circuitry 116 is instantiated by programmable circuitry executing interfacing instructions and/or configured to perform operations such as those represented by the flowchart of FIG. 7. In some examples, the filter circuitry 102 includes first means for interfacing. For example, the first means for interfacing may be implemented by the first interface circuitry 116. In some examples, the first interface circuitry 116 may be instantiated by programmable circuitry such as the example programmable circuitry 912 of FIG. 9. For instance, the first interface circuitry 116 may be instantiated by the example microprocessor 1000 of FIG. 10 executing machine executable instructions such as those implemented by at least blocks 702, 704 of FIG. 7. In some examples, the first interface circuitry 116 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the first interface circuitry 116 may be instantiated by any other combination of hardware, software, and/or firmware. For example, the first interface circuitry 116 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the second interface circuitry 118 is instantiated by programmable circuitry executing interfacing instructions and/or configured to perform operations such as those represented by the flowchart of FIG. 7. In some examples, the filter circuitry 102 includes second means for interfacing. For example, the second means for interfacing may be implemented by the first interface circuitry 116. In some examples, the first interface circuitry 116 may be instantiated by programmable circuitry such as the example programmable circuitry 912 of FIG. 9. For instance, the first interface circuitry 116 may be instantiated by the example microprocessor 1000 of FIG. 10 executing machine executable instructions such as those implemented by at least blocks 706, 708 of FIG. 7. In some examples, the first interface circuitry 116 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the first interface circuitry 116 may be instantiated by any other combination of hardware, software, and/or firmware. For example, the first interface circuitry 116 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the third metric calculator circuitry 120 is instantiated by programmable circuitry executing calculation instructions and/or configured to perform operations such as those represented by the flowchart of FIG. 7. In some examples, the filter circuitry 102 includes first means for determining. For example, the first means for determining may be implemented by the third metric calculator circuitry 120. In some examples, the third metric calculator circuitry 120 may be instantiated by programmable circuitry such as the example programmable circuitry 912 of FIG. 9. For instance, the third metric calculator circuitry 120 may be instantiated by the example microprocessor 1000 of FIG. 10 executing machine executable instructions such as those implemented by at least block 710 of FIG. 7. In some examples, the third metric calculator circuitry 120 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the third metric calculator circuitry 120 may be instantiated by any other combination of hardware, software, and/or firmware. For example, the third metric calculator circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

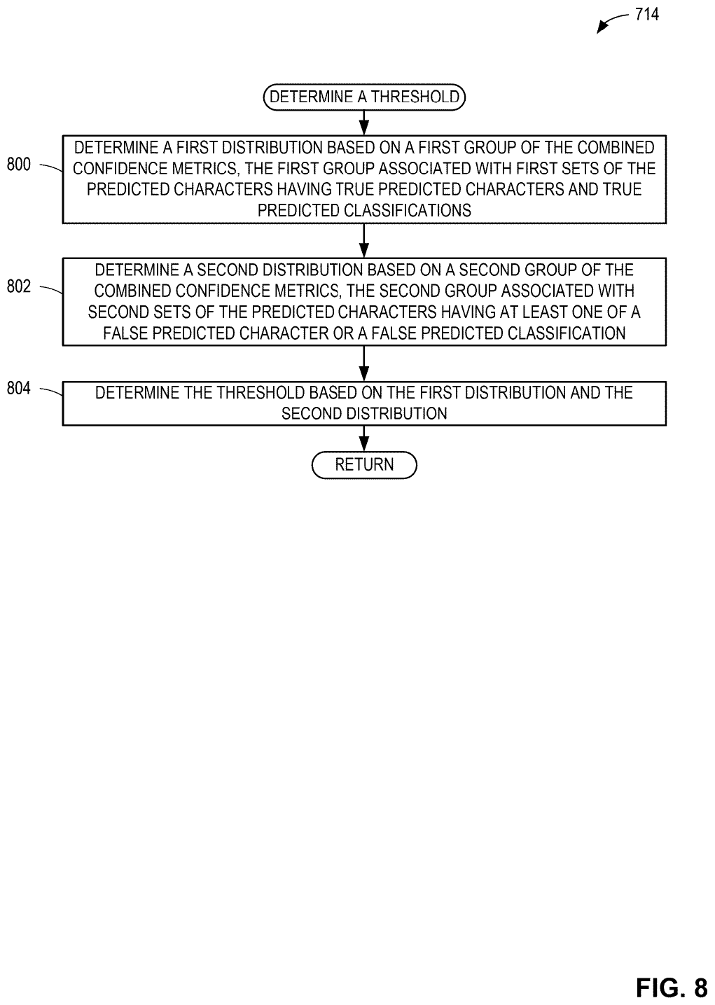

In some examples, the threshold determination circuitry 122 is instantiated by programmable circuitry executing threshold determination instructions and/or configured to perform operations such as those represented by the flowchart(s) of FIGS. 7 and 8. In some examples, the filter circuitry 102 includes second means for determining. For example, the second means for determining may be implemented by the threshold determination circuitry 122. In some examples, the threshold determination circuitry 122 may be instantiated by programmable circuitry such as the example programmable circuitry 912 of FIG. 9. For instance, the threshold determination circuitry 122 may be instantiated by the example microprocessor 1000 of FIG. 10 executing machine executable instructions such as those implemented by at least blocks 712, 714, 716 of FIG. 7 and blocks 800, 802, 804 of FIG. 8. In some examples, the threshold determination circuitry 122 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the threshold determination circuitry 122 may be instantiated by any other combination of hardware, software, and/or firmware. For example, the threshold determination circuitry 122 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the comparison circuitry 124 is instantiated by programmable circuitry executing comparison instructions and/or configured to perform operations such as those represented by the flowchart of FIG. 7. In some examples, the filter circuitry 102 includes means for comparing. For example, the means for comparing may be implemented by the comparison circuitry 124. In some examples, the comparison circuitry 124 may be instantiated by programmable circuitry such as the example programmable circuitry 912 of FIG. 9. For instance, the comparison circuitry 124 may be instantiated by the example microprocessor 1000 of FIG. 10 executing machine executable instructions such as those implemented by at least block 718 of FIG. 7. In some examples, the comparison circuitry 124 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the comparison circuitry 124 may be instantiated by any other combination of hardware, software, and/or firmware. For example, the comparison circuitry 124 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the transmission circuitry 126 is instantiated by programmable circuitry executing transmission instructions and/or configured to perform operations such as those represented by the flowchart of FIG. 7. In some examples, the filter circuitry 102 includes means for transmitting. For example, the means for transmitting may be implemented by the transmission circuitry 126. In some examples, the transmission circuitry 126 may be instantiated by programmable circuitry such as the example programmable circuitry 912 of FIG. 9. For instance, the transmission circuitry 126 may be instantiated by the example microprocessor 1000 of FIG. 10 executing machine executable instructions such as those implemented by at least blocks 720, 722, 724 of FIG. 7. In some examples, the transmission circuitry 126 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the transmission circuitry 126 may be instantiated by any other combination of hardware, software, and/or firmware. For example, the transmission circuitry 126 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 2A is an example receipt image 200 that can be included in the example input files 108 of FIG. 1. FIG. 2A includes example sets of predicted characters 202a-202k having corresponding combined confidence metrics 204a-204k. As described above, the receipt image 200 may be the result of a prior image acquisition operation by a market analyst, such as taking a photo of a physical receipt with an image acquisition device (e.g., a mobile phone). FIG. 2B illustrates how the filter circuitry 102 determines the combined confidence metric 204a associated with the set of predicted characters 202a.

Tuming to the illustrated example of FIG. 2A, the receipt image 200 can be included in the input files 108 of FIG. 1. The example first interface circuitry 116 causes the text recognition model 104 to predict characters in the receipt image 200. Further, the example first interface circuitry 116 causes the text recognition model 104 to determine first confidence metrics associated with the sets of the predicted characters 202a-202k. For example, the first metric calculator circuitry 128 determines the first confidence metrics associated with the sets of the predicted characters 202a-202k. In the example of FIG. 2A, the sets of the predicted characters 202a-202k include “1055,” “TWIST,” “LIMON,” “600 ML,” “1.0,” “132.00,” “1075,” “2LT,” “8PZ,” “1.0,” and “152.00.” In some examples, the filter circuitry 102 generates graphics and/or other effects to shade, highlight, emphasize, etc., the sets of the predicted characters 202a-202k.

The example first metric calculator circuitry 128 determines the first confidence metrics as likelihood values to determine how certain the sets of the predicted characters 202a-202k are true (e.g., accurate with respect to the actual sets of the characters in the image). The left side of FIG. 2B illustrates how the example first metric calculator circuitry 128 determines an example first confidence metric (e.g., an example first confidence metric 208 or an example first confidence metric 210) associated with the set of predicted characters 202a (described in detail below). Further, the example second interface circuitry 118 causes the classification model 106 to classify the sets of the predicted characters 202a-202k by determining predicted classifications for the sets of the predicted characters 202a-202k. In turn, the example second interface circuitry 118 causes the classification model 106 to determine confidence metrics associated with the predicted classifications. The right side of FIG. 2B illustrates how the example second metric calculator circuitry 130 determines an example second confidence metric (e.g., an example second confidence metric 216, an example second confidence metric 218, or an example second confidence metric 220) associated with the set of predicted characters 202a (described in detail below).

The example third metric calculator circuitry 120 determines the combined confidence metrics 204a-204k based on the first confidence metrics (from the text recognition model 104) and the second confidence metrics (from the classification model 106). For example, the third metric calculator circuitry 120 determines the combined confidence metrics 204a-204k by multiplying the first confidence metrics and the second confidence metrics. Further, as shown in FIG. 2A, the example third metric calculator circuitry 120 displays and/or edits the image of the receipt image 200 to include textual representations of the combined confidence metrics 204a-204k.

Turning to FIG. 2B, an example first diagram 206 (e.g., a representation of a data structure generated by the example first metric calculator circuitry 128) illustrates how the example first metric calculator circuitry 128 determines a first confidence metric associated with character prediction (e.g., a first confidence metric 208 and/or a first confidence metric 210). The example first diagram 206 includes the set of predicted characters 202a and fourth confidence metrics 212a-212e (e.g., individualized per-character confidence metric values) associated with each character in the set of the predicted characters 202a. In some examples, the first metric calculator circuitry 128 determines the first confidence metric 208 (e.g., an example first method—“Method 1”) by (i) determining the fourth confidence metrics 212a-212e associated with the predicted characters and (ii) determining the first confidence metric as an average of the fourth confidence metrics 212a-212e (Method 1). For example, the average of the fourth confidence metrics 212a-212e (e.g., 0.9, 0.5, 0.5, 0.9, 0.9) associated with the predicted characters (e.g., 6, 0, 0, M, L) is 0.74 (e.g., (0.9+0.5+0.5+0.9+0.9)/5=0.74). Alternatively, in some examples the first metric calculator circuitry 128 determines the first confidence metric 210 (e.g., an example second method—“Method 2”) by (i) determining the fourth confidence metrics 212a-212e associated with the predicted characters, (ii) selecting a first one of the fourth confidence metrics 212a-212e based on the first one of the fourth confidence metrics 212a-212e being less than the other fourth confidence metrics (e.g., selecting a lowest one of the fourth confidence metrics 212a-212e), and (iii) determining the first confidence metric as the first one of the fourth confidence metrics 212a-212e. For example, the fourth confidence metric 212b is less than the other fourth confidence metrics 212a, 212d, 212e (e.g., 0.5<0.9), so the first metric calculator circuitry 128 determines the fourth confidence metric 212b (or the fourth confidence metric 212c) as the first confidence metric 210 (e.g., 0.5) (Method 2).

Further, FIG. 2B includes an example second diagram 214 (e.g., a representation of a data structure generated by the example second metric calculator circuitry 130) that illustrates how the second metric calculator circuitry 130 determines the second confidence metric associated with classification prediction (e.g., a second confidence metric 216, a second confidence metric 218, and/or a second confidence metric 220). The example second diagram 214 includes the set of predicted characters 202a and fifth confidence metrics 222a-222e associated with predicted classifications of each character in the set of predicted characters 202a. In some examples, the example second metric calculator circuitry 130 determines the second confidence metric 216 by (i) determining the fifth confidence metrics 222a-222e associated with the predicted classifications for each of the predicted characters, (ii) determining the predicted classification of the set of predicted characters as the predominant/majority classification among the predicted characters, and (iii) determining the second confidence metric as an average of the fifth confidence metrics 222a-222e (Method 3). For example, the average of the fifth confidence metrics 222a-222e (e.g., 0.6, 0.45, 0.45, 0.98, 0.95) associated with the predicted characters (e.g., 6, 0, 0, M, L) is 0.69 (e.g., (0.6+0.45+0.45+0.98+0.95)/5=0.69). Further, the example second metric calculator circuitry 130 determines that the “Price” classification is the predominant classification because out of the five predicted classifications, “Price” is the most frequent. As such, the example second metric calculator circuitry 130 determines that the second confidence metric of 0.69 indicates that there is a 69% likelihood that the predicted classification of “Price” is true.

Alternatively, the example second metric calculator circuitry 130 determines the second confidence metric 218 by (i) determining the fifth confidence metrics 222a-222e associated with the predicted classifications for each of the predicted characters, (ii) determining average confidence metrics for the different predicted classifications, and (iii) determining the second confidence metric as the average confidence metric that is greater than the other average confidence metrics (Method 4). For example, the average of the fifth confidence metrics 222a-222e (e.g., 0.6, 0.45, 0.45) associated with the predicted characters (e.g., 6, 0, 0) corresponding to the predicted classification “Price” is 0.5 (e.g., (0.6+0.45+0.45)/3=0.5). Further, the average of the fifth confidence metrics 222a-222e (e.g., 0.98, 0.95) associated with the predicted characters (e.g., M, L) corresponding to the predicted classification “Description” is 0.97 (e.g., (0.98+0.95)/2=0.97). As such, the example second metric calculator circuitry 130 determines the second confidence metric is 0.97 based on 0.97 being greater than 0.5. Further, the example second metric calculator circuitry 130 determines that “Price,” rather than “Description,” is the appropriate classification based on 0.97 being greater than 0.5.

Alternatively, the example second metric calculator circuitry 130 determines the second confidence metric 220 by (i) determining the fifth confidence metrics 222a-222e associated with the predicted classifications for each of the predicted characters, (ii) determining weighted average confidence metrics for the different predicted classifications, and (iii) determining the second confidence metric as the weighted average confidence metric that is greater than the other weighted average confidence metrics (Method 5). For example, the weighted average of the fifth confidence metrics 222a-222e (e.g., 0.6, 0.45, 0.45) associated with the predicted characters (e.g., 6, 0, 0) corresponding to the predicted classification “Price” is 0.9 (e.g., (0.5)*3/5=0.3). Further, the weighted average of the fifth confidence metrics 222a-222e (e.g., 0.98, 0.95) associated with the predicted characters (e.g., M, L) corresponding to the predicted classification “Description” is 0.77 (e.g., (0.97)*2/5=0.39). As such, the example second metric calculator circuitry 130 determines the second confidence metric is 0.39 based on 0.39 being greater than 0.3. Further, the example second metric calculator circuitry 130 determines that “Description,” rather than “Price,” is the appropriate classification based on 0.39 being greater than 0.3.

The example first metric calculator circuitry 128 uses Method 1 to determine the first confidence metric 208 or Method 2 to determine the first confidence metric 210. Further, the example second metric calculator circuitry 130 uses Method 3 to determine the second confidence metric 216, Method 4 to determine the second confidence metric 218, or Method 5 to determine the second confidence metric 220. The example third metric calculator circuitry 120 determines the combined confidence metric 204a by multiplying the first confidence metric 210 (determined by the first metric calculator circuitry 128 using Method 2) and the second confidence metric 220 (determined by the second metric calculator circuitry 130 using Method 5). Thus, the example third metric calculator circuitry 120 determines the combined confidence metric 204a as 0.2 (e.g., 0.39*0.5=0.2).

The example comparison circuitry 124 determines whether at least one of the combined confidence metrics 204a-204k exceeds the threshold. In the example of FIGS. 2A and 2B, if the threshold determination circuitry 122 accesses or determines the threshold as 0.7, then the example comparison circuitry 124 determines that the combined confidence metric 204a does not satisfy the threshold (e.g., 0.2<0.7). Thus, the example transmission circuitry 126 prevents transmission of the image of the receipt image 200 to the example database 112. In other words, the example comparison circuitry 124 determines that the image of the receipt image 200 is associated with Category A (e.g., in need of additional processing) based on at least one of the combined confidence metrics 204a-204k (e.g., the combined confidence metric 204a) failing the threshold, and the transmission circuitry 126 prevents transmission of the image of the receipt image 200 to the database 112. Further, the example transmission circuitry 126 transmits the image of the receipt image 200 to the analysis queue 114 (e.g., via the network 132) for further processing.

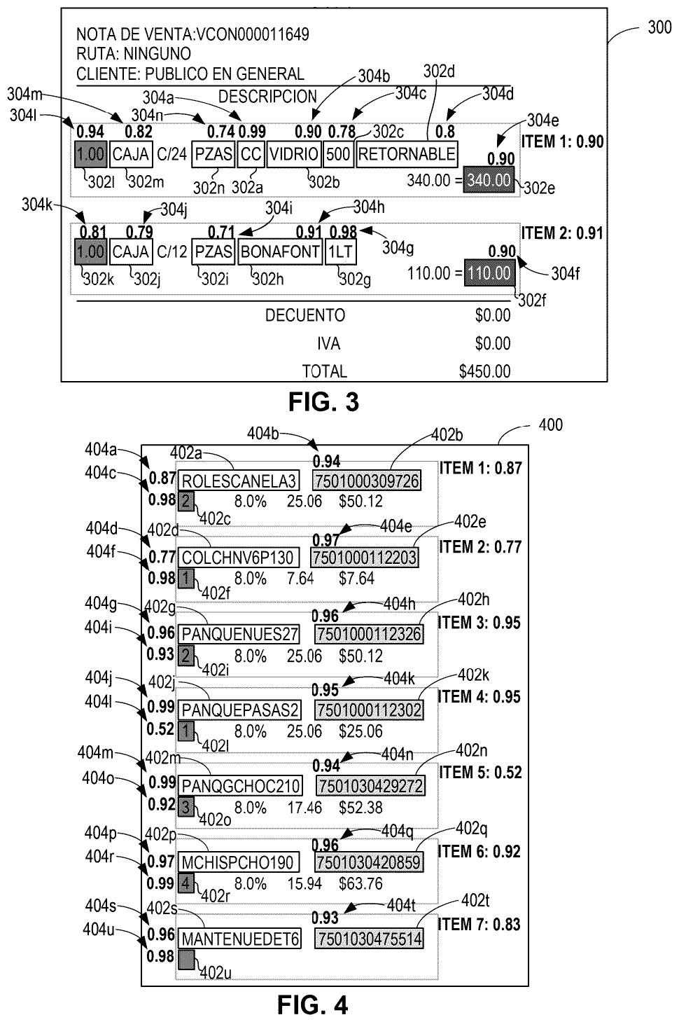

FIG. 3 is an example receipt image 300 that can be included in the example input files 108 of FIG. 1. Further, the example text recognition model 104 determines example sets of predicted characters 302a-302n. Additionally, the example third metric calculator circuitry 120 determines combined confidence metrics 304a-304n associated with the sets of the predicted characters 302a-302n. The example third metric calculator circuitry 120 determines the combined confidence metrics 304a-304n in accordance with the examples disclosed in connection with FIGS. 2A and 2B.

FIG. 4 is an example receipt image 400 that can be included in the example input files 108 of FIG. 1. Further, the example text recognition model 104 determines example sets of predicted characters 402a-402u. Additionally, the example third metric calculator circuitry 120 determines combined confidence metrics 404a-404u associated with the sets of the predicted characters 402a-402u. The example third metric calculator circuitry 120 determines the combined confidence metrics 404a-404u in accordance with the examples disclosed in connection with FIGS. 2A and 2B.

FIG. 5A is a table 501 illustrating an example first distribution 500 and an example second distribution 502 based on first (e.g., text-based), second (e.g., description/classification based), and combined (e.g., third) confidence metrics (as determined by the filter circuitry 102) associated with an example first image (e.g., the receipt image 200, the receipt image 300, the receipt image 400, etc.). The table 501 includes the mean, standard deviation (STD), minimum, maximum, 25^{th} percentile, 50^{th} percentile, and 75^{th} percentile to describe the statistical distribution of the combined confidence metrics in the each of the first and second distributions 500, 502. Referring to the first distribution 500 in the table 501, the mean indicates that the average combined confidence metric is 0.848 (e.g., the average is the sum of the combined confidence metrics divided by the number (quantity) of the combined confidence metrics). The standard deviation is a measure of how dispersed the data is in relation to the mean. So, in the first distribution 500, a standard deviation of 0.15 indicates that, on average, each of the combined confidence metrics in the first distribution 500 are about 0.15 away from the mean of 0.848. Further, the minimum combined confidence metric (e.g., the lowest combined confidence metric compared to all of the combined confidence metrics) in the first distribution 500 is 0.051. Additionally, the maximum combined confidence metric (e.g., the highest combined confidence metric compared to all of the combined confidence metrics) in the first distribution 500 is 0.997. The table 501 further includes indicators for each of the 25^{th} percentile, the 50^{th} percentile, and the 75^{th} percentile. In the first distribution 500, the 25^{th} percentile indicator illustrates that 25 percent of the combined confidence metrics are less than 0.798. The 50^{th} percentile indicator illustrates that 50 percent of the combined confidence metrics are greater than 0.905. The 75^{th} percentile indicator illustrates that 25 percent of the combined confidence metrics are greater than 0.955. Similarly, the table 501 describes the second distribution 502 in terms of the mean (0.614), standard deviation (0.209), minimum (0.027), maximum (0.988), 25^{th} percentile (0.459), 50^{th} percentile (0.600), and 75^{th} percentile (0.792).

FIG. 5B is a box and whisker plot 504 illustrating the first distribution 500 and the second distribution 502. In some examples, the first image is a representative image utilized by the threshold determination circuitry 122 to determine a threshold for image analysis. The example threshold determination circuitry 122 determines a threshold (to which combined confidence metrics are compared) based on the first distribution 500 and the second distributions 502. The example threshold determination circuitry 122 determines the first distribution 500 based on a first group of combined confidence metrics. In the example of FIG. 5A, the first group of the combined confidence metrics (the first distribution 500) is associated with first sets of predicted characters having true predicted characters and true predicted classifications. In other words, the first distribution 500 represents sets of predicted characters (e.g., the set 202b (e.g., “LIMON”) in FIG. 2A, the set 202c (e.g., “TWIST”) in FIG. 2B, etc.) that were both correctly identified (by the text recognition model 104) and correctly classified (by the classification model 106) (e.g., “CORRECT SETS”).

The example threshold determination circuitry 122 determines the second distribution 502 based on a second group of the combined confidence metrics. In the example of FIG. 5A, the second group of the combined confidence metrics is associated with second sets of predicted characters having at least one of a false predicted character or a false predicted classification. In other words, the second distribution 502 represent sets of predicted characters that were either incorrectly identified (by the text recognition model 104) or incorrectly classified (by the classification model 106) (e.g., “INCORRECT SETS”).

The example threshold determination circuitry 122 determines the threshold based on the average combined confidence metric associated with the first distribution 500 (e.g., 0.848) and the average combined confidence metric associated with the second distribution 502 (e.g., 0.614). For example, the threshold determination circuitry 122 determines the threshold as a number (e.g., 0.7) between the average combined confidence metrics (e.g., 0.614<0.7<0.848).

In FIG. 5B, the example threshold of 0.7 is represented by a line 506. If the example threshold determination circuitry 122 determines that the threshold is 0.7, then the threshold determination circuitry 122 determines that the majority of the combined confidence metrics (e.g., any of the combined confidence metrics in the 25^{th} percentile, the 50^{th} percentile, the 75^{th} percentile, etc.) in the first distribution 500 satisfy (e.g., exceed) the threshold. The example threshold of 0.7 is advantageous because such a threshold ensures that the majority of the combined confidence metrics having true predicted characters and true predicted classifications (e.g., associated with the first distribution 500) satisfy the threshold. In other words, a threshold of 0.7 reduces the chances that a combined confidence metric associated with a first set of predicted characters having true predicted characters and a true predicted classification will fail the threshold (e.g., reduces the chances of a false negative). The plot 504 of FIG. 5B visualizes this with the 25^{th}, 50^{th}, and 75^{th} percentiles (represented by box 508) of the first distribution 500 being on the right side of the line 506 (i.e., greater than the threshold of 0.7).

Additionally, if the example threshold determination circuitry 122 determines that the threshold is 0.7, then the threshold determination circuitry 122 determines that the majority of the combined confidence metrics in the second distribution 502 do not satisfy the threshold. The example threshold of 0.7 is advantageous because such a threshold ensures that the majority of the combined confidence metrics having at least one of a false set of predicted characters or a false predicted classification (e.g., associated with the second distribution 502) do not satisfy the threshold. In other words, a threshold of 0.7 reduces the chances that a combined confidence metric associated with a first set of predicted characters having false predicted characters and false predicted classifications will satisfy the threshold. The plot 504 of FIG. 5B visualizes this with most of the 25^{th}, 50^{th}, and 75^{th} percentiles (represented by box 510) of the second distribution 502 being on the left side of the line 506 (i.e., less than the threshold of 0.7).

FIG. 6A is a table 601 illustrating an example third distribution 600 and an example fourth distribution 602 based on the first (e.g., text-based), second (e.g., description/classification based), and combined (e.g., third) confidence metrics (as determined by the filter circuitry 102) associated with an example first image (e.g., the receipt image 200, the receipt image 300, the receipt image 400, etc.). Similar to the table 501, the table 601 describes the third distribution 600 in terms of the mean (0.822), standard deviation (0.176), minimum (0.121), maximum (0.995), 25^{th} percentile (0.735), 50^{th} percentile (0.896), and 75^{th} percentile (0.953). Further, similar to the table 501, the table 601 describes the fourth distribution 602 in terms of the mean (0.729), standard deviation (0.214), minimum (0.176), maximum (0.995), 25^{th} percentile (0.552), 50^{th} percentile (0.769), and 75^{th} percentile (0.932). FIG. 6B is a box and whisker plot 604 illustrating the third distribution 600 and the fourth distribution 602. The example third distribution 600 and fourth distribution 602 of FIG. 6A are similar to the example first and second distributions 500, 502 of FIG. 5A. However, the example threshold determination circuitry 122 determines the third distribution 600 based on a third group of combined confidence metrics associated with groups of sets of predicted characters associated with purchase items having true predicted characters and true predicted classifications. In other words, the third distribution 600 represents purchase items that were both correctly identified (by the text recognition model 104) and correctly classified (by the classification model 106) (e.g., “CORRECT ITEMS”).

In some examples, an item (e.g., a purchase item) can be associated with a group of sets of predicted characters in an example receipt image. For example, in the receipt image 200 of FIG. 2A, a first purchase item “TWIST LIMON 600 ML” (i.e., a mineral water drink) is associated with a first group of the sets of predicted characters 202a (e.g., “600 ML”), 202b (e.g., “LIMON”), and 202c (e.g., “TWIST”). Further, a second purchase item “2LT 8PZ” is associated with a second group of the sets of predicted characters 202h (e.g., “8PZ”) and 202i (e.g., “2LT”). The examples of FIGS. 6A and 6B are different from the examples of FIGS. 5A and 5B because the threshold determination circuitry 122 analyzes sets of predicted characters individually (e.g., a first set “TWIST,” a second set “LIMON,” a third set “600 ML”) in FIGS. 5A and 5B, whereas the threshold determination circuitry 122 analyzes groups of sets of predicted characters (e.g., a first group of sets “TWIST LIMON 600 ML,” a second group of sets “2LT 8PZ,” etc.) in FIGS. 6A and 6B.

Further, the example threshold determination circuitry 122 determines the fourth distribution 602 based on a fourth group of combined confidence metrics associated with groups of sets of predicted characters associated with purchase items having at least one of a false predicted character or a false predicted classification. In other words, the fourth distribution 602 represents purchase items were either incorrectly identified (by the text recognition model 104) or incorrectly classified (by the classification model 106) (e.g., “INCORRECT ITEMS”).

The example threshold determination circuitry 122 determines the threshold based on the average combined confidence metric associated with the third distribution 600 (e.g., 0.822) and the average combined confidence metric associated with the fourth distribution 602 (e.g., 0.729). For example, the threshold determination circuitry 122 determines the threshold as a number (e.g., 0.8) between the average combined confidence metrics (e.g., 0.729<0.8<0.822).

In FIG. 6B, the example threshold of 0.8 is represented by a line 606. If the example threshold determination circuitry 122 determines that the threshold is 0.8, then the threshold determination circuitry 122 determines that the majority of the combined confidence metrics in the third distribution 600 satisfy the threshold. The example threshold of 0.8 is advantageous because such a threshold ensures that the majority of the combined confidence metrics having true predicted characters and true predicted classifications (e.g., associated with the third distribution 600) satisfy the threshold. In other words, a threshold of 0.8 reduces the chances that a combined confidence metric associated with a true predicted character and a true predicted classification will fail the threshold. The plot 604 of FIG. 6B visualizes this with most of the 25^{th}, 50^{th}, and 75^{th} percentiles (represented by box 608) of the third distribution 600 being on the right side of the line 606 (i.e., greater than the threshold of 0.8).

Additionally, if the example threshold determination circuitry 122 determines that the threshold is 0.8, then the threshold determination circuitry 122 determines that the majority of the combined confidence metrics in the fourth distribution 602 do not satisfy the threshold. The example threshold of 0.8 is advantageous because such a threshold ensures that the majority of the combined confidence metrics having at least one of a false predicted character or a false predicted classification (e.g., associated with the fourth distribution 602) do not satisfy the threshold. In other words, a threshold of 0.8 reduces the chances that a combined confidence metric associated with false predicted characters and false predicted classifications will satisfy the threshold. The plot 604 of FIG. 6B visualizes this with most of the 25^{th}, 50^{th}, and 75^{th} percentiles (represented by box 610) of the fourth distribution 602 being on the left side of the line 606 (i.e., less than the threshold of 0.8).

Considering the plot 504 of FIG. 5B and the plot 604 of FIG. 6B, it may be more advantageous to analyze combined confidence metrics associated with sets of predicted characters as represented by the first and second distributions 500, 502 (FIGS. 5A and 5B) instead of analyzing combined confidence metrics associated with purchase items as represented by the third and fourth distributions 600, 602 (FIGS. 6A and 6B). Turning to plot 504 of FIG. 5B, the box 508 (representing the 25^{th}, 50^{th}, and 75^{th} percentiles in the first distribution 500 in the table 501) includes combined confidence metrics in a range of 0.798 to 0.955. Further, the box 510 (representing the 25^{th}, 50^{th}, and 75^{th} percentiles in the second distribution 502 in the table 501) includes combined confidence metrics in a range of 0.459 to 0.792. As such, the first and second distributions 500, 502 are distinct from one another because the boxes 508, 510 include different non-overlapping ranges of the combined confidence metrics. In fact, the range represented by box 510 in the first distribution 500 is numerically sequential to the range represented by box 510 in the second distribution 502 (e.g., 0.459<0.792<0.798<0.955). The example threshold determination circuitry 122 determines the threshold of 0.7 because 0.7 is a number that substantially represents a demarcation between the box 508 and the box 510.

Turning to plot 604 in FIG. 6B, the box 608 (representing the 25^{th}, 50^{th}, and 75^{th} percentiles in the third distribution 600 in table 601) includes combined confidence metrics in a range of 0.735 to 0.953. Further, the box 610 (representing the 25^{th}, 50^{th}, and 75^{th} percentiles in the fourth distribution 602 in the table 601) includes combined confidence metrics in a range of 0.552 to 0.932. As such, the third and fourth distributions 600, 602 are not distinct from one another because the boxes 608, 610 include an overlapping range of the combined confidence metrics. For example, the overlapping range includes combined confidence metrics of 0.735 to 0.932. This may cause the threshold determination circuitry 122 difficulty in determining an example threshold because there is no clear demarcation between the third and fourth distributions 600, 602. In other words, the third and fourth distributions 600, 602 are too similar, so an example threshold of 0.8 causes the threshold determination circuitry 122 to inaccurately pass certain ones of the combined confidence metrics in the fourth distribution 602 that should otherwise fail the 0.8 threshold. Similarly, an example threshold of 0.8 causes the threshold determination circuitry 122 to inaccurately flag certain ones of the combined confidence metrics in the third distribution 600 that should otherwise pass the 0.8 threshold.

This problem (wherein certain ones of the combined confidence metrics are not accurately categorized by the example threshold) is mitigated/alleviated in the example of FIGS. 5A and 5B. In FIGS. 5A and 5B, the majority of the combined confidence metrics are accurately categorized by the example threshold of 0.7, as previously described. As such, it may be more advantageous to analyze combined confidence metrics associated with sets of predicted characters as represented by the first and second distributions 500, 502 (FIGS. 5A and 5B) instead of analyzing combined confidence metrics associated with purchase items as represented by the third and fourth distributions 600, 602 (FIGS. 6A and 6B) because the example threshold of 0.7 in FIGS. 5A and 5B more accurately categorizes the combined confidence metrics in the first and second distributions 500, 502.

While an example manner of implementing the filter circuitry 102 of FIG. 1 is illustrated in FIG. 1, one or more of the elements, processes, and/or devices illustrated in FIG. 1 may be combined, divided, re-arranged, omitted, eliminated, and/or implemented in any other way. Further, the example first interface circuitry 116, the example second interface circuitry 118, the example third metric calculator circuitry 120, the example threshold determination circuitry 122, the example comparison circuitry 124, the example transmission circuitry 126, and/or, more generally, the example filter circuitry 102 of FIG. 1, may be implemented by hardware alone or by hardware in combination with software and/or firmware. Thus, for example, any of the example first interface circuitry 116, the example second interface circuitry 118, the example third metric calculator circuitry 120, the example threshold determination circuitry 122, the example comparison circuitry 124, the example transmission circuitry 126, and/or, more generally, the example filter circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example filter circuitry 102 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the filter circuitry 102 of FIG. 1 and/or representative of example operations which may be performed by programmable circuitry to implement and/or instantiate the filter circuitry 102 of FIG. 1, are shown in FIGS. 7 and 8. The machine readable instructions may be one or more executable programs or portion(s) of one or more executable programs for execution by programmable circuitry such as the programmable circuitry 912 shown in the example programmable circuitry platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7 and 8, many other methods of implementing the example filter circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 7 and 8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to evaluate an example image. The example machine-readable instructions and/or the example operations 700 of FIG. 7 begin at block 702, at which the example first interface circuitry 116 causes the text recognition model 104 to predict characters in an image. For example, the first interface circuitry 116 causes the text recognition model 104 to predict characters in an image of the receipt image 200 included in the input files 108. In turn, the text recognition model 104 accesses the image of the receipt image 200 from the input files 108, scans the image, and predicts the characters in the image.

At block 704, the example first interface circuitry 116 causes the text recognition model 104 to determine first confidence metrics associated with sets of the predicted characters. The example text recognition model 104 includes the first metric calculator circuitry 128 to determine the first confidence metrics. For example, the first metric calculator circuitry 128 determines the first confidence metrics associated with the sets of the predicted characters 202a-202k in the receipt image 200. The example first metric calculator circuitry 128 determines the first confidence metrics as likelihood values to determine how certain the sets of the predicted characters 202a-202k are true.

At block 706, the example second interface circuitry 118 causes the classification model 106 to classify the sets of the predicted characters 202a-202k by determining predicted classifications for the sets of the predicted characters 202a-202k.

At block 708, the example second interface circuitry 118 causes the classification model 106 to determine second confidence metrics associated with the predicted classifications. The example classification model 106 includes the second metric calculator circuitry 130 to determine the second confidence metrics. For example, the second metric calculator circuitry 130 determines the second confidence metrics associated with the predicted classifications as likelihood values to determine how certain the predicted classifications are true (e.g., accurate with respect to the actual classifications of the sets of the characters in the image).

At block 710, the example third metric calculator circuitry 120 determines combined confidence metrics based on the first confidence metrics (from the text recognition model 104) and the second confidence metrics (from the classification model 106). For example, the third metric calculator circuitry 120 determines the combined confidence metrics 204a-204k by multiplying the first confidence metrics and the second confidence metrics. In other words, for each set of predicted characters, the example third metric calculator circuitry 120 multiplies a first confidence metric (determined by the text recognition model 104) and a second confidence metric (determined by the classification model 106) to determine a combined confidence metric (e.g., the combined confidence metric 204a in FIGS. 2A and 2B). As such, each set of predicted characters includes a corresponding combined confidence metric.

At block 712, the example threshold determination circuitry 122 determines whether to generate, determine, and/or otherwise revise a threshold or access an existing threshold. In some examples, the threshold determination circuitry 122 determines a threshold periodically, aperiodically, and/or based on one or more triggers. In other examples, the threshold determination circuitry 122 determines a threshold when the image is a first (e.g., first in time) image included in the input files 108 being used to train at least one of the text recognition model 104 or the classification model 106. In such examples, control of the process proceeds to block 714. Alternatively, if the image is a first image in a series of images subject to processing by the filter circuitry 102, then the threshold determination circuitry 122 accesses the threshold (e.g., the threshold determined by the threshold determination circuitry 122 during one or more previous training phase(s)). In such examples, control of the process proceeds to block 716.

At block 714, the threshold determination circuitry 122 determines the example threshold as described in connection with FIG. 8 below.

At block 716, the threshold determination circuitry 122 accesses the threshold. In some examples, the threshold determination circuitry 122 accesses a previously determined threshold.

At block 718, the example comparison circuitry 124 determines whether at least one of the combined confidence metrics 204a-204k satisfies (e.g., exceeds) the threshold. For example, the combined confidence metric 204a is 0.2 and the threshold is 0.7, then the example comparison circuitry 124 determines that the combined confidence metric 204a does not satisfy the threshold (e.g., 0.2<0.7). In such examples, control of the process proceeds to block 720. Alternatively, the comparison circuitry 124 determines that the combined confidence metric 204b satisfies the threshold. For example, the combined confidence metric 204b is 0.92 and the threshold is 0.7, then the example comparison circuitry 124 determines that the combined confidence metric 204b satisfies the threshold (e.g., 0.92>0.7). In such examples, control of the process proceeds to block 722.

At block 720, the example transmission circuitry 126 prevents transmission of the image of the receipt image 200 to the database 112 (e.g., in response to the combined confidence metric 204a not satisfying the threshold). In other words, when the comparison circuitry 124 determines that the combined confidence metric 204a does not satisfy (e.g., is less than) the threshold, then the comparison circuitry 124 determines that the image of the receipt image 200 is associated with Category A (e.g., in need of additional processing), and the transmission circuitry 126 prevents transmission of the image to the database 112. Further, the example transmission circuitry 126 transmits the image to the analysis queue 114 (e.g., via the network 132) for further processing.

At block 722, the example transmission circuitry 126 enables transmission of the image to the database 112. In other words, when the comparison circuitry 124 determines that the combined confidence metrics satisfy the threshold, then the example comparison circuitry 124 determines that the image is associated with Category B (e.g., having completed processing), and the transmission circuitry 126 enables transmission of the image to the database 112.

At block 724, the example transmission circuitry 126 determines whether to evaluate another image. For example, if the transmission circuitry 126 determines to evaluate another image in the input files 108 (e.g., the receipt image 300, the receipt image 400, etc.), then control of the process returns to block 702. Alternatively, if the example transmission circuitry 126 determines not to evaluate another image, then the process ends.

FIG. 8 is a flowchart representative of example machine readable instructions and/or example operations that may be executed, instantiated, and/or performed by programmable circuitry to determine an example threshold. The example machine-readable instructions and/or the example operations of FIG. begin at block 800, at which the threshold determination circuitry 122 determines a first distribution based on a first group of the combined confidence metrics, the first group associated with first sets of the predicted characters having true predicted characters and true predicted classifications. For example, the threshold determination circuitry 122 determines the first distribution 500 of FIG. 5A.

At block 802, the example threshold determination circuitry 122 determines a second distribution based on a second group of the combined confidence metrics, the second group associated with second sets of the predicted characters having at least one of a false predicted character of a false predicted classification. For example, the threshold determination circuitry 122 determines the second distribution 502 of FIG. 5A.

At block 804, the example threshold determination circuitry 122 determines the threshold based on the first distribution 500 and the second distribution 502. For example, the threshold determination circuitry 122 determines the threshold based on the average combined confidence metric associated with the first distribution 500 (e.g., 0.848) and the average combined confidence metric associated with the second distribution 502 (e.g., 0.614). For example, the threshold determination circuitry 122 determines the threshold as a number (e.g., 0.7) between the average combined confidence metrics (e.g., 0.614<0.7<0.848). Then, control of the process returns to FIG. 7.

FIG. 9 is a block diagram of an example programmable circuitry platform 900 structured to execute and/or instantiate the example machine-readable instructions and/or the example operations of FIGS. 7 and 8 to implement the filter circuitry 102 of FIG. 1. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the example first interface circuitry 116, the example second interface circuitry 118, the example third metric calculator circuitry 120, the example threshold determination circuitry 122, the example comparison circuitry 124, the example transmission circuitry 126, and the example filter circuitry 102.

The programmable circuitry 912 of the illustrated example

includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 7 and 8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 7 and 8 to effectively instantiate the circuitry of FIG. 1 as logic circuits to perform operations corresponding to those machine readable instructions. In some such examples, the circuitry of FIG. 1 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 7 and 8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart(s) of FIGS. 7 and 8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7 and 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7 and 8. As such, the FPGA circuitry 1100 may be configured and/or structured to effectively instantiate some or all of the operations/functions corresponding to the machine readable instructions of the flowchart(s) of FIGS. 7 and 8 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 7 and 8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 7 and 8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowchart(s) of FIGS. 7 and 8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 7 and 8, and/or an ASIC may be configured and/or structured to perform third operation(s)/function(s) corresponding to a third portion of the machine readable instructions represented by the flowcharts of FIGS. 7 and 8.

It should be understood that some or all of the circuitry of FIG. 1 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 1 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

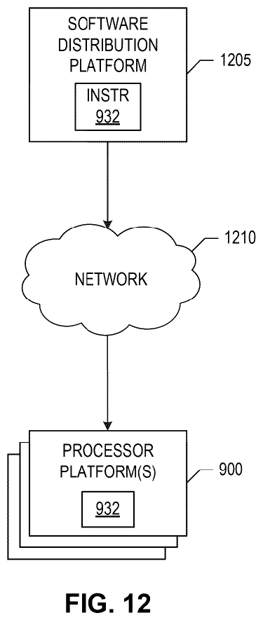

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 7 and 8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 7 and 8, may be downloaded to the example programmable circuitry platform 900, which is to execute the machine readable instructions 932 to implement the filter circuitry 102. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that reduce the amount of human intervention required to review results of image recognition techniques. Examples disclosed herein significantly reduce or eliminate a need for auditors to spend numerous hours reviewing the result of the image recognition process, thus conserving processing resources, facilitating faster process executing, and/or helping green energy conservation initiatives. Disclosed systems, apparatus, articles of manufacture, and methods improve the efficiency of using a computing device by alleviating the cost of expensive processing equipment, the computing power, and/or the storage capability associated with any server, processor, model, etc., programmed to re-analyze input files (e.g., images) associated with image processing techniques. Disclosed systems, apparatus, articles of manufacture, and methods are accordingly directed to one or more improvement(s) in the operation of a machine such as a computer or other electronic and/or mechanical device.

Example 1 includes an apparatus comprising interface circuitry, machine-readable instructions, and at least one processor circuit to be programmed by the machine-readable instructions to cause a text recognition model to predict characters in an image, and determine first confidence metrics associated with sets of the predicted characters, cause a classification model to classify the sets of the predicted characters by determining predicted classifications for the sets of the predicted characters, and determine second confidence metrics associated with the predicted classifications, determine third confidence metrics based on the first confidence metrics and the second confidence metrics, compare the third confidence metrics to a threshold, and in response to the third confidence metrics satisfying the threshold, prevent a transmission of the image to a database.

Example 2 includes the apparatus of example 1, wherein one or more of the at least one processor circuit is to determine the threshold by determining a first statistical distribution based on a first group of the third confidence metrics, the first group associated with first sets of the predicted characters having true predicted characters and true predicted classifications, determining a second statistical distribution based on a second group of the third confidence metrics, the second group associated with second sets of the predicted characters having at least one of a false predicted character or a false predicted classification, and determining the threshold based on the first statistical distribution and the second statistical distribution.

Example 3 includes the apparatus of example 1, wherein the predicted characters include at least one of a predicted letter, a predicted number, or a predicted symbol.

Example 4 includes the apparatus of example 1, wherein one or more of the at least one processor circuit is to determine one of the first confidence metrics by determining fourth confidence metrics associated with first ones of the predicted characters, the first ones of the predicted characters associated with a first set of the predicted characters, selecting a first one of the fourth confidence metrics based on the first one of the fourth confidence metrics being less than the other fourth confidence metrics, and determining the one of the first confidence metrics as the first one of the fourth confidence metrics, the one of the first confidence metrics associated with the first set of the predicted characters.

Example 5 includes the apparatus of example 1, wherein one or more of the at least one processor circuit is to determine one of the second confidence metrics by determining fourth confidence metrics associated with first ones of the predicted characters, the fourth confidence metrics associated with predicted classifications of the first ones of the predicted characters, the first ones of the predicted characters associated with a first set of the predicted characters, selecting a first one of the fourth confidence metrics based on the first one of the fourth confidence metrics being greater than the other ones of the fourth confidence metrics, and determine the one of the second confidence metrics based as the first one of the fourth confidence metrics, the one of the second confidence metrics associated with the first set of the predicted characters.

Example 6 includes the apparatus of example 1, wherein the text recognition model is an optical character recognition (OCR) model.

Example 7 includes the apparatus of example 1, wherein the classification model is a natural language processing (NLP) model.

Example 8 includes At least one non-transitory machine-readable medium comprising machine-readable instructions to cause at least one processor circuit to at least cause a text recognition model to predict characters in an image, and determine first confidence metrics associated with sets of the predicted characters, cause a classification model to classify the sets of the predicted characters by determining predicted classifications for the sets of the predicted characters, and determine second confidence metrics associated with the predicted classifications, determine third confidence metrics based on the first confidence metrics and the second confidence metrics, compare the third confidence metrics to a threshold, and in response to the third confidence metrics satisfying the threshold, prevent a transmission of the image to a database.

Example 9 includes the at least one non-transitory machine-readable medium of example 8, wherein one or more of the at least one processor circuit is to determine the threshold by determining a first distribution based on a first group of the third confidence metrics, the first group associated with first sets of the predicted characters having true predicted characters and true predicted classifications, determining a second distribution based on a second group of the third confidence metrics, the second group associated with second sets of the predicted characters having at least one of a false predicted character or a false predicted classification, and determining the threshold based on the first distribution and the second distribution.

Example 10 includes the at least one non-transitory machine-readable medium of example 8, wherein the predicted characters include at least one of a predicted letter, a predicted number, or a predicted symbol.

Example 11 includes the at least one non-transitory machine-readable medium of example 8, wherein the machine-readable instructions are to cause one or more of the at least one processor circuit to determine one of the first confidence metrics by determining fourth confidence metrics associated with first ones of the predicted characters, the first ones of the predicted characters associated with a first set of the predicted characters, selecting a first one of the fourth confidence metrics based on the first one of the fourth confidence metrics being less than the other fourth confidence metrics, and determining the one of the first confidence metrics as the first one of the fourth confidence metrics, the one of the first confidence metrics associated with the first set of the predicted characters.

Example 12 includes the at least one non-transitory machine-readable medium of example 8, wherein the machine-readable instructions are to cause one or more of the at least one processor to determine one of the second confidence metrics by determining fourth confidence metrics associated with first ones of the predicted characters, the fourth confidence metrics associated with predicted classifications of the first ones of the predicted characters, the first ones of the predicted characters associated with a first set of the predicted characters, selecting a first one of the fourth confidence metrics based on the first one of the fourth confidence metrics being greater than the other ones of the fourth confidence metrics, and determine the one of the second confidence metrics based as the first one of the fourth confidence metrics, the one of the second confidence metrics associated with the first set of the predicted characters.

Example 13 includes the at least one non-transitory machine-readable medium of example 8, wherein the text recognition model is an optical character recognition (OCR) model.

Example 14 includes the at least one non-transitory machine-readable medium of example 8, wherein the classification model is a natural language processing (NLP) model,

Example 15 includes a method comprising causing, by at least one processor circuit programmed by at least one instructions, a text recognition model to predict characters in an image, and determine first confidence metrics associated with sets of the predicted characters, causing, by one or more of the at least one processor circuit, a classification model to classify the sets of the predicted characters by determining predicted classifications for the sets of the predicted characters, and determine second confidence metrics associated with the predicted classifications, determining. by one or more of the at least one processor circuit, third confidence metrics based on the first confidence metrics and the second confidence metrics, comparing, by one or more of the at least one processor circuit, the third confidence metrics to a threshold, and in response to the third confidence metrics satisfying the threshold, preventing, by one or more of the at least one processor circuit, a transmission of the image to a database.

Example 16 includes the method of example 15, wherein one or more of the at least one processor circuit is to determine the threshold by determining a first distribution based on a first group of the third confidence metrics, the first group associated with first sets of the predicted characters having true predicted characters and true predicted classifications, determining a second distribution based on a second group of the third confidence metrics, the second group associated with second sets of the predicted characters having at least one of a false predicted character or a false predicted classification, and determining the threshold based on the first distribution and the second distribution.

Example 17 includes the method of example 15, wherein the predicted characters include at least one of a predicted letter, a predicted number, or a predicted symbol.

Example 18 includes the method of example 15, wherein one or more of the at least one processor circuit is to determine one of the first confidence metrics by determining fourth confidence metrics associated with first ones of the predicted characters, the first ones of the predicted characters associated with a first set of the predicted characters, selecting a first one of the fourth confidence metrics based on the first one of the fourth confidence metrics being less than the other fourth confidence metrics, and determining the one of the first confidence metrics as the first one of the fourth confidence metrics, the one of the first confidence metrics associated with the first set of the predicted characters.

Example 19 includes the method of example 15, wherein one or more of the at least one processor circuit is to determine one of the second confidence metrics by determining fourth confidence metrics associated with first ones of the predicted characters, the fourth confidence metrics associated with predicted classifications of the first ones of the predicted characters, the first ones of the predicted characters associated with a first set of the predicted characters, selecting a first one of the fourth confidence metrics based on the first one of the fourth confidence metrics being greater than the other ones of the fourth confidence metrics, and determine the one of the second confidence metrics based as the first one of the fourth confidence metrics, the one of the second confidence metrics associated with the first set of the predicted characters.

Example 20 includes the method of example 15, wherein the text recognition model is an optical character recognition (OCR) model.

Example 21 includes the method of example 15, wherein the classification model is a natural language processing (NLP) model.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
cause a text recognition model to:
predict characters in an image; and
determine first confidence metrics associated with sets of the predicted characters;
cause a classification model to:
classify the sets of the predicted characters by determining predicted classifications for the sets of the predicted characters; and
determine second confidence metrics associated with the predicted classifications;
determine third confidence metrics based on the first confidence metrics and the second confidence metrics;
compare the third confidence metrics to a threshold; and
in response to the third confidence metrics satisfying the threshold, prevent a transmission of the image to a database.

2. The apparatus of claim 1, wherein one or more of the at least one processor circuit is to determine the threshold by:
determining a first statistical distribution based on a first group of the third confidence metrics, the first group associated with first sets of the predicted characters having true predicted characters and true predicted classifications;
determining a second statistical distribution based on a second group of the third confidence metrics, the second group associated with second sets of the predicted characters having at least one of a false predicted character or a false predicted classification; and
determining the threshold based on the first statistical distribution and the second statistical distribution.

3. The apparatus of claim 1, wherein the predicted characters include at least one of a predicted letter, a predicted number, or a predicted symbol.

4. The apparatus of claim 1, wherein one or more of the at least one processor circuit is to determine one of the first confidence metrics by:
determining fourth confidence metrics associated with first ones of the predicted characters, the first ones of the predicted characters associated with a first set of the predicted characters;
selecting a first one of the fourth confidence metrics based on the first one of the fourth confidence metrics being less than the other fourth confidence metrics; and
determining the one of the first confidence metrics as the first one of the fourth confidence metrics, the one of the first confidence metrics associated with the first set of the predicted characters.

5. The apparatus of claim 1, wherein one or more of the at least one processor circuit is to determine one of the second confidence metrics by:
determining fourth confidence metrics associated with first ones of the predicted characters, the fourth confidence metrics associated with predicted classifications of the first ones of the predicted characters, the first ones of the predicted characters associated with a first set of the predicted characters;
selecting a first one of the fourth confidence metrics based on the first one of the fourth confidence metrics being greater than the other ones of the fourth confidence metrics; and
determine the one of the second confidence metrics based as the first one of the fourth confidence metrics, the one of the second confidence metrics associated with the first set of the predicted characters.

6. The apparatus of claim 1, wherein the text recognition model is an optical character recognition (OCR) model.

7. The apparatus of claim 1, wherein the classification model is a natural language processing (NLP) model.

8. At least one non-transitory machine-readable medium comprising machine-readable instructions to cause at least one processor circuit to at least:
cause a text recognition model to:
predict characters in an image; and
determine first confidence metrics associated with sets of the predicted characters;
cause a classification model to:
classify the sets of the predicted characters by determining predicted classifications for the sets of the predicted characters; and
determine second confidence metrics associated with the predicted classifications;
determine third confidence metrics based on the first confidence metrics and the second confidence metrics;
compare the third confidence metrics to a threshold; and
in response to the third confidence metrics satisfying the threshold, prevent a transmission of the image to a database.

9. The at least one non-transitory machine-readable medium of claim 8, wherein one or more of the at least one processor circuit is to determine the threshold by:
determining a first distribution based on a first group of the third confidence metrics, the first group associated with first sets of the predicted characters having true predicted characters and true predicted classifications;
determining a second distribution based on a second group of the third confidence metrics, the second group associated with second sets of the predicted characters having at least one of a false predicted character or a false predicted classification; and
determining the threshold based on the first distribution and the second distribution.

10. The at least one non-transitory machine-readable medium of claim 8, wherein the predicted characters include at least one of a predicted letter, a predicted number, or a predicted symbol.

11. The at least one non-transitory machine-readable medium of claim 8, wherein the machine-readable instructions are to cause one or more of the at least one processor circuit to determine one of the first confidence metrics by:
determining fourth confidence metrics associated with first ones of the predicted characters, the first ones of the predicted characters associated with a first set of the predicted characters;
selecting a first one of the fourth confidence metrics based on the first one of the fourth confidence metrics being less than the other fourth confidence metrics; and
determining the one of the first confidence metrics as the first one of the fourth confidence metrics, the one of the first confidence metrics associated with the first set of the predicted characters.

12. The at least one non-transitory machine-readable medium of claim 8, wherein the machine-readable instructions are to cause one or more of the at least one processor to determine one of the second confidence metrics by:
determining fourth confidence metrics associated with first ones of the predicted characters, the fourth confidence metrics associated with predicted classifications of the first ones of the predicted characters, the first ones of the predicted characters associated with a first set of the predicted characters;
selecting a first one of the fourth confidence metrics based on the first one of the fourth confidence metrics being greater than the other ones of the fourth confidence metrics; and
determine the one of the second confidence metrics based as the first one of the fourth confidence metrics, the one of the second confidence metrics associated with the first set of the predicted characters.

13. The at least one non-transitory machine-readable medium of claim 8, wherein the text recognition model is an optical character recognition (OCR) model.

14. The at least one non-transitory machine-readable medium of claim 8, wherein the classification model is a natural language processing (NLP) model.

15. A method comprising:
causing, by at least one processor circuit programmed by at least one instructions, a text recognition model to:
predict characters in an image; and
determine first confidence metrics associated with sets of the predicted characters;
causing, by one or more of the at least one processor circuit, a classification model to:
classify the sets of the predicted characters by determining predicted classifications for the sets of the predicted characters; and
determine second confidence metrics associated with the predicted classifications;
determining, by one or more of the at least one processor circuit, third confidence metrics based on the first confidence metrics and the second confidence metrics;
comparing, by one or more of the at least one processor circuit, the third confidence metrics to a threshold; and
in response to the third confidence metrics satisfying the threshold, preventing, by one or more of the at least one processor circuit, a transmission of the image to a database.

16. The method of claim 15, wherein one or more of the at least one processor circuit is to determine the threshold by:
determining a first distribution based on a first group of the third confidence metrics, the first group associated with first sets of the predicted characters having true predicted characters and true predicted classifications;
determining a second distribution based on a second group of the third confidence metrics, the second group associated with second sets of the predicted characters having at least one of a false predicted character or a false predicted classification; and
determining the threshold based on the first distribution and the second distribution.

17. The method of claim 15, wherein the predicted characters include at least one of a predicted letter, a predicted number, or a predicted symbol.

18. The method of claim 15, wherein one or more of the at least one processor circuit is to determine one of the first confidence metrics by:
determining fourth confidence metrics associated with first ones of the predicted characters, the first ones of the predicted characters associated with a first set of the predicted characters;
selecting a first one of the fourth confidence metrics based on the first one of the fourth confidence metrics being less than the other fourth confidence metrics; and
determining the one of the first confidence metrics as the first one of the fourth confidence metrics, the one of the first confidence metrics associated with the first set of the predicted characters.

19. The method of claim 15, wherein one or more of the at least one processor circuit is to determine one of the second confidence metrics by:
determining fourth confidence metrics associated with first ones of the predicted characters, the fourth confidence metrics associated with predicted classifications of the first ones of the predicted characters, the first ones of the predicted characters associated with a first set of the predicted characters;
selecting a first one of the fourth confidence metrics based on the first one of the fourth confidence metrics being greater than the other ones of the fourth confidence metrics; and
determine the one of the second confidence metrics based as the first one of the fourth confidence metrics, the one of the second confidence metrics associated with the first set of the predicted characters.

20. The method of claim 15, wherein the text recognition model is an optical character recognition (OCR) model.

21. (canceled)
